(19) United States
(12) Patent Application Publication
(10) Pub. No.: US 2015/0245172 A1
(43) Pub. Date: Aug. 27, 2015

(54) CENTRALIZED DATABASE FOR INFRASTRUCTURE DETECTION AND INCIDENT REPORTING

(71) Applicant: UtilityLink, LLC, Bethesda, MD (US)

(72) Inventor: Joel Fernebok, Bethesda, MD (US)

(21) Appl. No.: 14/633,013

(22) Filed: Feb. 26, 2015

Related U.S. Application Data
(60) Provisional application No. 61/944,845, filed on Feb. 26, 2014.

(51) Int. Cl. H04W 4/02; H04W 4/04

(52) U.S. Cl. CPC H04W 4/02; H04W 4/04

(57) ABSTRACT

Systems and methods for utility infrastructure analysis are described. Systems and methods may include identifying a location of a user; identifying one or more radio frequency identification transmitters; determining the location of the one or more radio frequency identification transmitters; accessing one or more items of information regarding the location of the user from a centralized database; integrating the one or more items of information with the location of the one or more radio frequency identification transmitters; approving the integrated information for entry into the centralized database; and updating the centralized database with the integrated information regarding the one or more radio frequency identification transmitters.

### FIELD OF THE INVENTION

The present invention relates to systems and methods for utility infrastructure detection, and, more specifically, to systems and methods for locating of utility infrastructure and updating a centralized database regarding the utility infrastructure.

### BACKGROUND OF THE INVENTION

Various types of hidden and/or underground structures are found throughout the world. Examples may include, but are not limited to, electrical, telecommunications, fuel supply, water supply, sewage, and other utility lines or pipes, as well a loop systems for such things as invisible fences to keep pets or livestock confined or to monitor security. In addition to lines and pipes, storage tanks and vessels are often kept underground.

A wide variety of industries use hidden and/or underground structure for functional and/or aesthetic reasons. Exemplary industries may include utility companies, manufacturing plants and facilities, government, construction industry, hospitals, airports, gas stations, private and commercial properties, real-estate industry, research labs, universities, cities, municipalities, oil and gas industry, and more.

It may be vital to know the exact location of hidden and/or underground structures when repairs and/or additions are made to industrial and urban structures, or whenever activity is occurring around such hidden and/or underground structures. Unfortunately, the exact location of these objects deviate from “as-built” drawings, design drawings and other mechanisms used to collect location data, if these records are available at all. As a result, when repair services or additions to facilities require construction in the vicinity of these hidden and/or underground structures, the construction often experiences unanticipated problems such as breakage, re-routing, and delays. To perform cost effective detection of such underground objects and objects concealed in and around erected structures and potential construction sites, it is essential that the presence, location and depth of such lines be accurately determined. Locating these hidden and/or underground structures using available techniques is costly and ineffective.

Existing techniques for detecting underground assets include the use of technologies such as ground penetrating radar (GPR). GPR-based systems, however, generate large amounts of unnecessary data that is non-specific or non-descriptive of the location and line identified, and, therefore, result in inaccuracies and a lower level of specifiable detail about the object. GPR tends to be unable to distinguish between the signals returned by an underground object of interest from that of the signals returned by other sub-surface objects.

Global positioning systems (GPS) are also used to locate assets. Existing maps have been digitized and the data is stored in a database. This data is accessed using a GPS enabled handheld device in the field to locate the assets. There are many problems with this approach. The accuracy of most GPS devices is 3 to 5 m unless Differential GPS (DGPS) is used which is expensive and requires extensive processing time. Given this margin of error, locations identified with GPS also lack in repeatability. Additionally, GPS requires line of sight with satellites and does not function properly in shades of trees, buildings, etc.

Sometimes metal detectors are used in addition to GPS to locate hidden and/or underground structures. Metal detectors have problems such as failing to distinguish between a metallic utility line and another piece of metal that is adjacent to it, moreover for items such as fiber optic cables, or fiberglass structures, metal detectors may not provide a reliable signal.

Needs exist for an accurate, cost efficient system and method for locating, storing, and providing information regarding hidden and/or underground structures.

### SUMMARY OF THE INVENTION

Embodiments of the present invention solve many of the problems and/or overcome many of the drawbacks and disadvantages of the prior art by providing systems and methods for locating, storing, and providing information regarding hidden and/or underground structures.

Embodiments of the present invention may include systems and methods for locating, storing, and providing information regarding hidden and/or underground structures. Systems and methods may include identifying a location of a user; identifying one or more radio frequency identification transmitters; determining the location of the one or more radio frequency identification transmitters; accessing one or more items of information regarding the location of the user from a centralized database; integrating the one or more items of information with the location of the one or more radio frequency identification transmitters; approving the integrated information for entry into the centralized database; and updating the centralized database with the integrated information regarding the one or more radio frequency identification transmitters.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows an exemplary architecture diagram and associated functionality components.

FIG. 2 shows an exemplary system for locating, storing, and providing information regarding hidden and/or underground structures.

FIG. 3 shows an exemplary system for computational aspects of a system for locating, storing, and providing information regarding hidden and/or underground structures.

FIG. 4 shows an exemplary application flow process.

FIG. 5 shows an exemplary application environment and select integration touch points.

### DETAILED DESCRIPTION OF THE PREFERRED EMBODIMENTS

Systems and methods are described for using various tools and procedures for locating, storing, and providing information regarding hidden and/or underground structures. In certain embodiments, the tools and procedures may be used in conjunction with locating, storing, and providing information regarding hidden and/or underground structures. The examples described herein relate to use of radio frequency identification (RFID) for illustrative purposes only. The systems and methods described herein may be used for many different industries and purposes, including the construction industry, government regulators, industrial plant owners, commercial and residential property owners, and/or other industries completely. In particular, the systems and methods may be used for any industry or purpose where location of hidden and/or underground structures is needed. For multi-step processes or methods, steps may be performed by one or more different parties, servers, processors, etc.

In certain embodiments, systems and methods may identify a location of hidden and/or underground structures. For purposes of this disclosure, the terms hidden and/or underground structures and utility infrastructure are used interchangeably. Location of utility infrastructure may be identified based on one or more connections to official incidents reported combined with discovering, collecting, updating, and aggregating crowdsourced data points for additional validation.

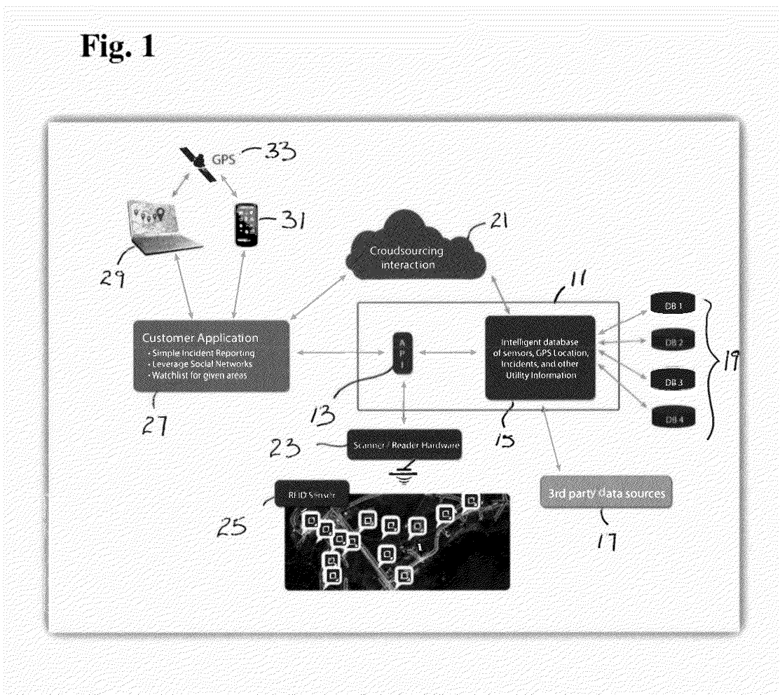

FIG. 1 describes exemplary components for a mobile and/or web-based application that provides for collecting and consolidating utility infrastructure location and incident reporting activities. A central system 11 may be located on a computing device that includes one or more processors and one or more memories, such as a computer, server, etc. The central system 11 may include one or more application program interfaces (API) 13 for interacting with various internal and external components.

The central system 11 may have one or more internal intelligent utility databases 15 and/or interact with one or more remote databases for this purpose. The one or more intelligent utility databases 15 may include information regarding sensors, global positioning (GPS) locations, incidents, and other utility information. The one or more intelligent databases 15 may interact with various other information sources to compile and/or store information. Exemplary information sources may include third party data sources 17, external databases 19, and/or crowdsourcing information 21. The one or more intelligent databases 15 may store information such that it is readily locatable and available for the API 13. Information may include, but is not limited to, type of marker (RFID, metal, etc.), source of information (who uploaded it or is it from a utility master map), how is it stored (as a database record with individual, searchable attributes), storage is displayable by layers (individual upload, utility company), date of record (within last 6 months, all time, etc.).

The API 13 may interact with one or more systems. For example, the API 13 may interact with an internal or external scanner or reader 23. The scanner or reader 23 may be an RFID reader. The scanner or reader 23 may interact with one or more sensors or locators 25 in the field. For example, the one or more sensors or locators 25 may be RFID sensors embedded within, coupled to, or otherwise indicative of a location of utility infrastructure. In certain embodiments, the one or more sensors or locators 25 may be integral with underground utilities, such as RFID chips embedded within cables or piping. In certain embodiments, the one or more sensors or locators 25 may be located at a predetermined frequency along an underground utility or at specified locations on an underground utility, such as every 5, 10, 15 feet along a cable or pipe, or at the corners of an underground tank.

The API 13 may also be in communication with a user application 27. The user application 27 may operate on a variety of platforms, such as a mobile computing device 29, a mobile phone 31, or other devices used in the field. Preferably, the devices 29, 31 are capable of interacting with a GPS system 33 for determining location of the devices 29, 31. The user application 27 may provide for reporting incidents, leveraging of social networks, providing watchlists for given areas, etc. The user application 27 may interact directly with a crowdsourcing system 21 and/or may receive crowdsourcing information via the central system 11, such as, for example, via the one or more intelligent databases 15 and/or API 13. The interaction may be via direct connection or a network connection, such as the Internet. An application can also operate offline. While offline, the application may save and store information to interface with the system later when a connection exists. Data may be stored in a send/confirm queue until a connection exists.

Although not required, the systems and methods are described in the general context of computer program instructions executed by one or more computing devices that can take the form of a traditional server/desktop/laptop; mobile device such as a smartphone or tablet; etc. Computing devices typically include one or more processors coupled to data storage for computer program modules and data. Key technologies include, but are not limited to, the multi-industry standards of Microsoft and Linux/Unix based Operating Systems; databases such as SQL Server, Oracle, NOSQL, and DB2; Business Analytic/Intelligence tools such as SPSS, Cognos, SAS, etc.; development tools such as Java,.NET Framework (VB.NET, ASP.NET, AJAX.NET, etc.); and other e-Commerce products, computer languages, and development tools. Such program modules generally include computer program instructions such as routines, programs, objects, components, etc., for execution by the one or more processors to perform particular tasks, utilize data, data structures, and/or implement particular abstract data types. While the systems, methods, and apparatus are described in the foregoing context, acts and operations described hereinafter may also be implemented in hardware.

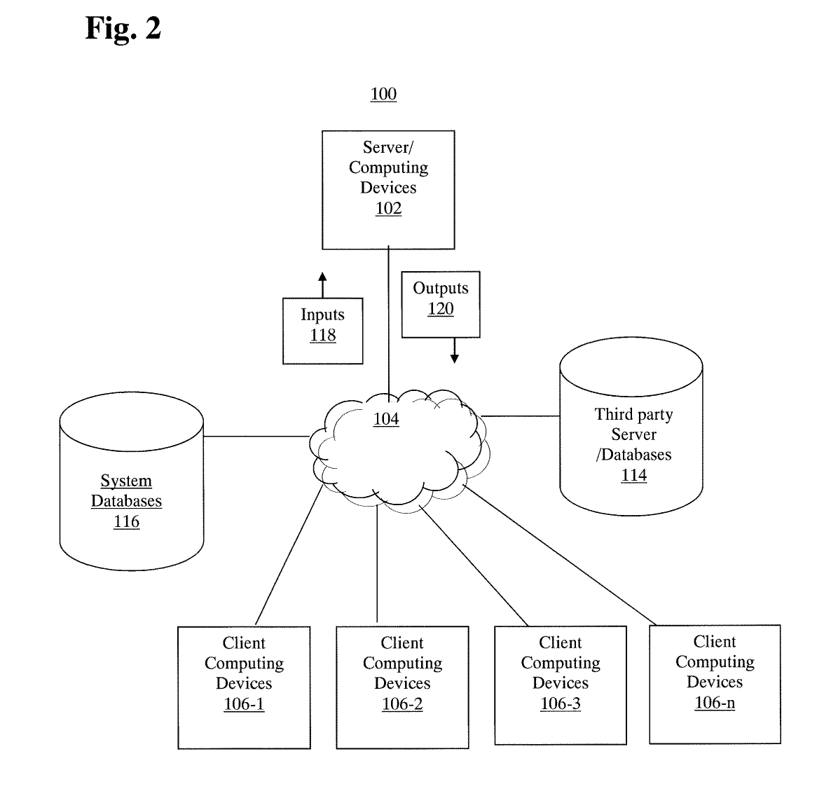

FIG. 2 shows an exemplary system 100 for using predictive analytics for system administration according to one embodiment. In this exemplary implementation, system 100 may include one or more servers/computing devices 102 (e.g., server 1, server 2, . . . , server n) operatively coupled over network 104 to one or more client computing devices 106-1 to 106-n, which may include one or more consumer computing devices, one or more provider computing devices, one or more remote access devices, etc. The one or more servers/computing devices 102 may also be operatively connected, such as over a network, to one or more third party servers/databases 114 (e.g., database 1, database 2, . . . , database n). The one or more servers/computing devices 102 may also be operatively connected, such as over a network, to one or more system databases 116 (e.g., database 1, database 2, . . . , database n). Various devices may be connected to the system, including, but not limited to, client computing devices, consumer computing devices, provider computing devices, remote access devices, etc. This system may receive inputs 118 and outputs 120 from the various computing devices, servers and databases. In certain embodiments, inputs may include, but are not limited to, individual input requests, file uploads, and/or mass import of entire utility systems data. In certain embodiments, inputs may include, but are not limited to:
Individual data updates: Individual data updates may be added to a queue for review before modifying a base system;
Validity checks: A determination may be made if conflicting data shows any repeating or proximity patterns;
File uploads: File uploads may cover many different concurrent updates to the system;
New user account requests: May be used for new users registering to use the system;
Help requests: Help requests may be from users having issues while using the system or a question to be answered; and
Bug reports: May be from an auto-generated message from the local application crashing or detecting a problem, or the user identifying an issue to be addressed.

Server/computing device 102 may represent, for example, any one or more of a server, a general-purpose computing device such as a server, a personal computer (PC), a laptop, a smart phone, a tablet, and/or so on. Networks 104 represent, for example, any combination of the Internet, local area network(s) such as an intranet, wide area network(s), cellular networks, WIFI networks, and/or so on. Such networking environments are commonplace in offices, enterprise-wide computer networks, etc. Client computing devices 106, which may include at least one processor, represent a set of arbitrary computing devices executing application(s) that respectively send data inputs to server/computing device 102 and/or receive data outputs from server/computing device 102. Such computing devices include, for example, one or more of desktop computers, laptops, mobile computing devices (e.g., tablets, smart phones, human wearable devices), server computers, and/or so on. In this implementation, the input data comprises, for example, sensor data, and/or so on, for processing with server/computing device 102. In one implementation, the data outputs include, for example, emails, templates, forms, and/or so on. Embodiments of the present invention may also be used for collaborative projects with multiple users logging in and performing various operations on a data project from various locations. Embodiments of the present invention may be web-based, smart phone-based and/or tablet-based or human wearable device based.

In this exemplary implementation, server/computing device 102 includes at least one processor coupled to a system memory. System memory may include computer program modules and program data.

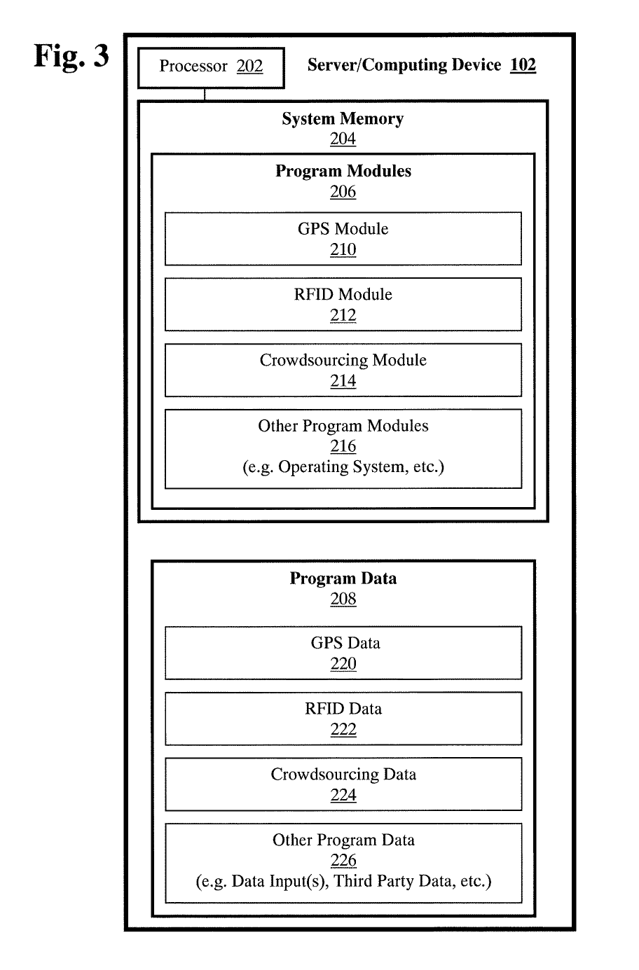

In this exemplary implementation, server/computing device 102 includes at least one processor 202 coupled to a system memory 204, as shown in FIG. 3. System memory 204 may include computer program modules 206 and program data 208. In this implementation program modules 206 may include GPS module 210, RFID module 212, crowdsourcing module 214, and other program modules 216 such as an operating system, device drivers, etc. Each program module 210 through 216 may include a respective set of computer-program instructions executable by processor(s) 202. This is one example of a set of program modules and other numbers and arrangements of program modules are contemplated as a function of the particular arbitrary design and/or architecture of server/computing device 102 and/or system 100 (FIG. 1). Additionally, although shown on a single server/computing device 102, the operations associated with respective computer-program instructions in the program modules 206 could be distributed across multiple computing devices. Program data 208 may include GPS data 220, RFID data 222, crowdsourcing data 224, and other program data 226 such as data input(s), third party data, and/or others.

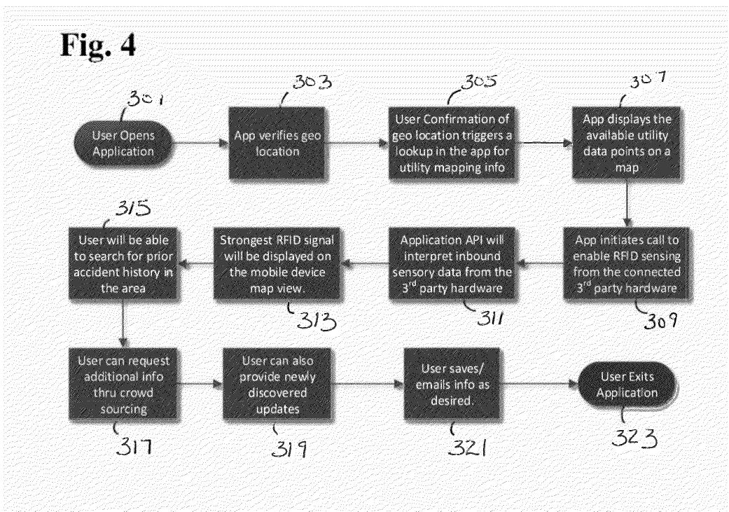

FIG. 4 is an overview of an exemplary application work flow according to an embodiment of the invention. The following steps are exemplary, and intended only for illustration purposes. Each of the steps may be optional, modified, and/or removed from the process for different purposes. Furthermore, the steps may be performed in any order to suit a particular application.

In certain embodiments, a user may open an application 301. An application may be a traditional software program, an application for a phone or other portable computing device. The application may run as installed software and/or as a web-based, browser application. An application program interface (API) may be provided. The API may conform to web standards, such as, but not limited to, Representational State Transfer (REST), and/or industry standards, such as, but not limited to, Simple Object Access Protocol (SOAP) or Open Geospatial Consortium (OGC). By following the industry and standard development conventions, the API may be easy to consume and readily extensible for future enhancements.

The application may verify the current location of the user based on location information available to the application 303. In certain embodiments, this may be through a GPS device. The GPS device may be integral to the computing device and/or may be an external GPS device in communication with the computing device. The communication may be wired or wireless. The interaction with the GPS device may return current location to the application. Current location may be in the form of latitude and longitude coordinate, an image on a map, and/or other location indications.

The application may then ask the user to verify the location provided by the GPS device. The user may verify the location, such as by clicking a ‘verify’ button, or may indicate the location is incorrect 305. If the information is incorrect, the application may ask the GPS device to again identify the location of the user.

The location data may not be specifically reliant on an active GPS connection. In certain embodiments, a user would need to be able to enter an address, GPS coordinates, or other location identifying information to access information offsite or access information without GPS location information available. Furthermore, RFID chips scanned may have location information that can be used to verify, clarify, or establish location information.

The verification of location may prompt the application to search one or more databases for any known utility location/mapping information in close proximity of the returned GPS location. In certain embodiments, the database may be a centralized database. The one or more databases may include public utility databases, third party databases, and/or crowdsourced information. The application may search for relevant utility mapping information from available validated databases and crowdsourced input for any known utility location/mapping information. The application may retrieve the available utility mapping information from the data sources and the application database.

In certain embodiments, data from multiple sources may be aggregated. For example, data from utility companies, developers, governments, etc. may be aggregated. Data may not be limited to collected field data from end users. A centralized database may include digital map imports from one or more third party utilities or other similar sources.

In certain embodiments, data from one or more sources may be rendered in real-time or near real-time. In response to a user request, the system may access data from a data source and render the data rather than having information from third party data sources stored at a centralized server. This rendering may eliminate security issues associated with third parties storing data on a centralized system. The centralized system may create a replica of the data, but the source data may originate from a third party database via secure data transmission between components.

The application may display the retrieved data in a visual form 307. In certain embodiments, the retrieved data may be represented as a map with utility data points. The utility data points may be layered and/or highlighted with use of color representing known utility items hidden and/or underground for that specific location. Known database and crowdsourced information may be denoted on the visual display. In certain embodiments, crowdsourced data may be layered on top of other data sources. Distinctions may be made for a user between crowdsourced data and other types of data.

Map page interaction may depend on user actions. For example, when a user zooms out and is able to see more of a map, more information may need to be sent to populate additional data points on the user's map view. Additionally, if the user pans the view of the map, new data points may need to be loaded as different areas are viewed in the application.

In certain embodiments, the retrieved data may be displayed in three-dimensions, such as using three-dimensional visualization capabilities. The three-dimensional view may provide users with a visualization that allows them to see not only location of underground utilities, but also relative depth of the underground utilities.

The three-dimensional visualization may be representative. Data on the order, direction, and depth of the different lines underground may be translated by the application to show the elements under the ground while representing relative depth from the surface and each other while using industry color coding to give an example of what things should look like under the ground. This representation may rely completely on the accuracy of the data that is already in the system. The system may normalize the depth numbers from the database and may assume industry standard depths when the real depth data has not yet been recorded. To a user, the representation may be a map of distance from the surface to the first pipe, top to bottom of the first pipe, bottom of the first pipe to the top of the next, and so on.

The computing device may have one or more RFID sensing devices. In certain embodiments, the computing device may have integral hardware and/or software for detecting RFID signals. In certain embodiments, separate hardware and/or software may be in communication with the computing device that is capable of picking up RFID signals from embedded or attached RFID chips on utility infrastructure.

The application may use an application program interface (API) and initiate a call to enable RFID sensing through the one or more RFID sensing devices 309. The one or more RFID sensing devices may scan for available RFID signals. The application API may interpret inbound sensory data from the one or more RFID sensing devices 311. As the user moves through a specified area, the signal strength of the nearest RFID chip may be detected and that data point may be passed through the API to the application for processing and verification. Detected RFID signals may be prominently displayed on the layered visual view on the computing device 313.

The user may be able to search for prior accident history in the area 315. Prior accident history may include any records that relate to specific utility infrastructure. Prior accident history may come from government data sources, such as, but not limited to, fire department, police department, etc.; public records; utility companies; news reports; individual updates; crowdsourced information; and any other available source of information. Prior accident history may be displayed on the visual display along with other utility infrastructure information.

‘Events’ may be stored as they were uploaded to the system. In certain embodiments, minimal event data may include location, type of accident, type of utility infrastructure, owner of the utility and date. Optional data may include one or more of: a summary of the trigger and damage, images of the event, date the utility infrastructure was repaired and the party that performed the repairs, and open text notes from anyone who can add information to the event object.

Crowd sourced data specific to the user location can optionally be viewed. The crowdsourced information may optionally be marked differently than records from other sources, such as government or utility records, etc.

The user may send a request for crowd sourcing help to identify any other utility infrastructure information related to the specified location 317. In certain embodiments, crowdsourcing may involve pushing information out to clients, such as utilities, government agencies, or other infrastructure owners.

In certain embodiments, the crowdsourcing may be performed in a closed community. For example, a trade association specific to utility or land development or construction companies may be members of a closed community. Alternatively, a closed community may be limited to utilities providing service in the location. The closed community may be set up to include any number or subset of individuals and/or organizations. Additionally, membership may be determined by consensus or by an administrative body. In certain embodiments, users may register before being able to post requests for crowdsourcing information or responding to crowdsourcing requests. In certain embodiments, the crowdsourcing request may be extended to a broader community via use of multiple social networks and channels. Social networks may include FACEBOOK, TWITTER, etc.

The user may also have the option to enter and share information discovered in the course of performing work 319. This can be captured in the system and broadcast out to the crowd sourced community as a benefit for participating.

In certain embodiments, geoprocessing may be used. Geoprocessing may take an input dataset, perform an operation on that dataset, and return a result of the operation as an output dataset. A database can publish geoprocessing services that allow submission to the server and return a set of results. Certain embodiments may leverage a normal Relational Data Base Management System (RDBMS) functionality for indexing, searching, and storage. This may be combined with any other technologies that may improve upon the storage, indexing and retrieval of the data. As data size grows in volume, NoSQL DB approaches may be applied to improve performance and scalability.

Embodiments may include a system for approval of data before the data is entered into the one or more databases, such as a centralized database. Instead of allowing an end user to post directly to a database and/or map, the data may be reviewed and approved. The review and approval may be performed by an administrator or may happen automatically. The approval may reference existing data in the centralized database. If discrepancies are found, the data may be flagged for follow-up by an administrator and/or the end user. A notification may be sent to the administrator and/or end user. If the data is approved, it may be added to the centralized database.

In certain embodiments, a system may receive many different data points with possible updates and new information coming in from many different sources. As such, the system may have a queue of updates to be applied to the database, which may have to be validated manually. This queue of data updates may exist in a separate part of the system where it does not interfere with live data and may update and replace the live data or create new data points if it is determined to be valid. The source, time, and location of the submissions may be stored in with the new data points so a record can be kept of both the frequency and accuracy of different submissions so the system can have a record of trustworthy sources.

Certain embodiments may allow for tracking of data and/or updates. Historic transactions and/or updates may be tracked and searchable. Annotations regarding tracking and/or updating information may be stored and/or displayed.

Data fields/storage space may be allocated in the database specifically for historic tracking and recall of accidents/events. At periodic intervals, as items are updated, a copy of the existing version of information on a location may be saved and moved to the archived section of data, with logging of specific changes and associated times. Then, if needed, a user may browse to a list of all past versions of the information; including both the type of data that was entered and the time it was replaced. This may provide a safety net if data needs to be restored to an earlier point for a specific location or list of locations. Also, if a historic version of data for a location is recalled, the current data existing the moment before the change may be saved and stored as its own snapshot in the history list of items. The saving and storing of data points/changes may be automatic to minimize risk, no action from the user may be required to save informational states.

In certain embodiments, all location points may have consistent data fields for information. Some location points may be open text fields for any character input. Some locations points may be set data options that may be available via a mutually exclusive or inclusive list. Since the fields may be linked via appropriate relationships, they may be easy to sort and search. One or more fields may be reserved specifically for future searching and organizing data instead of being specifically based on recording new information or updating the system with alerts. These data points may include sets of finite options for searching and tagging and may also contain an option for some users to add in new tags or free text both as a point of note for future viewers and as a way to speed up searching in specific cases.

Certain embodiments may provide for backloading of existing data with plans and/or multiple records.

The user can save session information and/or send a copy of the information 321. Information may be sent via email, SMS, MMS, etc. The user may exit the application 323.

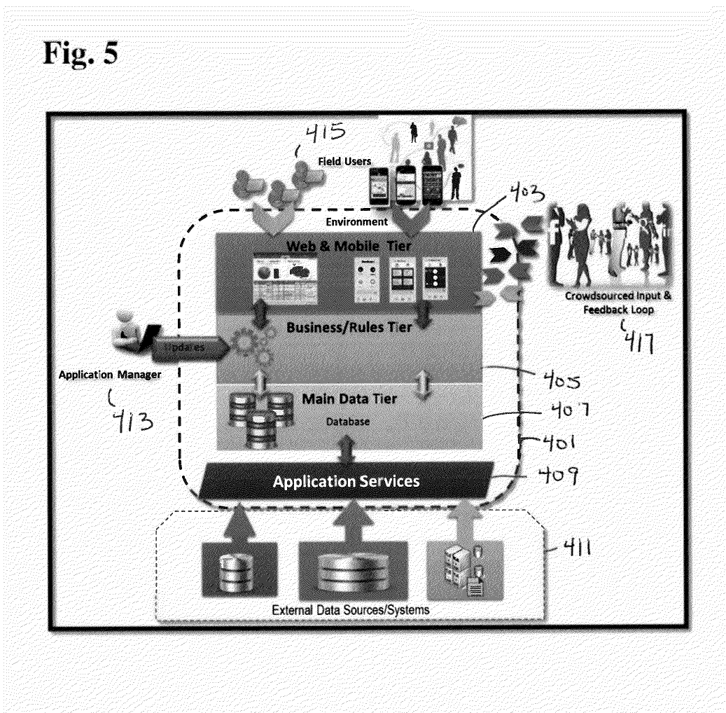

FIG. 5 shows an exemplary flow for crowdsourced utility location and incident reporting. The following steps are exemplary, and intended only for illustration purposes. Each of the steps may be optional, modified, and/or removed from the process for different purposes. Furthermore, the steps may be performed in any order to suit a particular application.

A user may open an application for crowdsourced utility location and incident reporting. The user may select an option to report an incident or provide information via crowdsourcing. The application may verify the current location of the user based on location information available to the application. In certain embodiments, this may be through a GPS device. The GPS device may be integral to the computing device and/or may be an external GPS device in communication with the computing device. The communication may be wired or wireless. The interaction with the GPS device may return current location to the application. Current location may be in the form of latitude and longitude coordinate, an image on a map, and/or other location indications.

The application may then ask the user to verify the location provided by the GPS device. The user may verify the location, such as by clicking a ‘verify’ button, or may indicate the location is incorrect. If the information is incorrect, the application may ask the GPS device to again identify the location of the user.

The location data may not be specifically reliant on an active GPS connection. In certain embodiments, a user would need to be able to enter an address, GPS coordinates, or other location identifying information to access information offsite or access information without GPS location information available. Furthermore, RF chips scanned may have location information that can be used to verify, clarify, or establish location information.

The user may be presented with ability to record incident information or distribute crowdsourced information. The application may auto populate relevant names as well as specific location information. The user may select a type of utility infrastructure, such as, for example, a utility piping type. The user may enter one or more details regarding utility infrastructure and/or the incident. Details for location information may include, but are not limited to, location, status, condition, etc. Details for incidents may include, but are not limited to, near miss, damage, potential cause of incident, inaccurate information provided, etc. The end user may save information and may have the option to push the information to one or more known databases and/or a crowdsourcing community.

A main system 401 may include various tiers. Tiers may include a web and mobile tier 403, a business or rules tier 405, and/or a main data tier 407. The web and mobile tier 403 may include a presentation layer for information coming from the business or rules tier 405, and the data collection layer for information going to the business or rules tier 405. The business or rules tier 405 may include rules for layering and rendering map data from utility companies, crowdsourced data and any other map related information. The business or rules tier 405 may also contain data validation rules, algorithms for determining routing and/or follow up steps when crowdsourced data is received, algorithms for determining instructional/best practices information stored in the main data tier 407 to deliver to the web and mobile tier 403 based on specific inputs from users. Also computed in the business or rules tier 405 may be algorithms to convert GPS coordinates to map plots using external databases. The business or rules tier 405 may have computations to align mapping data from multiple sources into the correct database storage fields, and retrieve that information when requested by the web and mobile tier 403.

The tiers 403, 405, 407 may interact with one another to distribution information and functionality. One or more of the tiers 403, 405, 407 may be in communication with an application services module 409. The application services module may provide for interaction with external data sources and/or systems 411.

An application manager 413 may provide updates to the main system 401 as necessary or desired. Field users 415 may provide information to the main system 401. In certain embodiments, the field users may provide information to the main system 401 via the web and mobile tier 403. A crowdsourced input and feedback loop 417 may provide interaction between the main system 401 and a crowdsourcing community. In certain embodiments, the information regarding a utility infrastructure may be pushed or accessed by a third party, such as a utility, government or other infrastructure owner. The third party may then provide additional details from the field to supplement the centralized database.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A computerized method for utility infrastructure analysis, the computerized method comprising the steps of:
identifying a location of a user;
identifying one or more radio frequency identification transmitters;
determining the location of the one or more radio frequency identification transmitters;
accessing one or more items of information regarding the location of the user from a centralized database;
integrating the one or more items of information with the location of the one or more radio frequency identification transmitters;
approving the integrated information for entry into the centralized database; and
updating the centralized database with the integrated information regarding the one or more radio frequency identification transmitters.

2. The method of claim 1, further comprising displaying the integrated information on a visual display.

3. The method of claim 1, further comprising the step of requesting the one or more items of information from a crowdsourcing application.

4. The method of claim 1, wherein the one or more items of information are related to the location of the one or more radio frequency transmitters.

5. The method of claim 1, wherein the one or more items of information are incidents related to the one or more radio frequency transmitters.

6. The method of claim 1, wherein the updating comprises providing data regarding the one or more radio frequency transmitters to a crowdsourcing community.

7. The method of claim 1, further comprising accessing one or more databases to determine additional information regarding the one or more radio frequency transmitters.

8. The method of claim 7, further comprising integrating the additional information regarding the one or more radio frequency transmitters with the one or more items of information and the location of the one or more radio frequency identification transmitters.

9. The method of claim 8, wherein the additional information regarding the one or more radio frequency transmitters is prior accident history.

10. The method of claim 8, wherein the additional information regarding the one or more radio frequency transmitters is location information.

11. A system for utility infrastructure analysis, the system comprising:
one or more processors;
one or more processors, wherein the one or more processors execute the following steps:
identifying a location of a user;
identifying one or more radio frequency identification transmitters;
determining the location of the one or more radio frequency identification transmitters;
accessing one or more items of information regarding the location of the user from a centralized database;
integrating the one or more items of information with the location of the one or more radio frequency identification transmitters;
approving the integrated information for entry into the centralized database; and
updating the centralized database with the integrated information regarding the one or more radio frequency identification transmitters.

12. The system of claim 11, further comprising displaying the integrated information on a visual display.

13. The system of claim 11, further comprising the step of requesting the one or more items of crowdsourced information from a crowdsourcing application.

14. The system of claim 11, wherein the one or more items of information are related to the location of the one or more radio frequency transmitters.

15. The system of claim 11, wherein the one or more items of information are incidents related to the one or more radio frequency transmitters.

16. The system of claim 11, wherein the updating comprises providing information regarding the one or more radio frequency transmitters to a crowdsourcing community.

17. The system of claim 11, further comprising accessing one or more databases to determine additional information regarding the one or more radio frequency transmitters.

18. The system of claim 17, further comprising integrating the additional information regarding the one or more radio frequency transmitters with the one or more items of information and the location of the one or more radio frequency identification transmitters.

19. The system of claim 18, wherein the additional information regarding the one or more radio frequency transmitters is prior accident history.

20. The system of claim 18, wherein the additional information regarding the one or more radio frequency transmitters is location information.

21. The systems and methods described herein.
